(19) United States
(12) Patent Application Publication
(10) Pub. No.: US 2005/0264536 A1
(43) Pub. Date: Dec. 1, 2005

(54) Indication system for use with portable electronic devices

(75) Inventors: Marko Kyrola, Kangasala (FI); Juha Simola, Tampere (FI)

Correspondence Address: FOLEY & LARDNER, 321 NORTH CLARK STREET, SUITE 2800, CHICAGO, IL, 60610-4764, US

(73) Assignee: Nokia Corporation

(21) Appl. No.: 10/858,132

(22) Filed: Jun. 1, 2004

(51) Int. Cl. G09G 5/08

(52) U.S. Cl. 345/173

(57) ABSTRACT

A portable electronic device, comprising: a housing having an open position and a closed position, a touch-sensitive input area, a data input device for interacting with the touch-sensitive input area and a data input device storage region for the data input device. The device also includes a system for alerting a user when the housing is in the closed position and the data input device is not positioned within the data input device storage region.

The present invention relates to portable electronic devices. More particularly, the present invention relates to portable electronic devices having a touch-sensitive display and an input device for use with the touch-sensitive display.

### BACKGROUND OF THE INVENTION

A wide variety of portable electronic devices are widely available for both personal and business use. For example, there are a wide variety of types of cellular phones, portable radio communications devices, personal digital assistants (PDA), portable computers, and combinations thereof currently on the market. These devices provide a wide range of services, ranging from Internet access to electronic mail to personal organization systems, to even various electronic games.

One type of portable electronic device is foldable and serves as both a personal digital assistant and as a cellular phone. When the unit is in an open position, a touch-sensitive display is accessible for manipulation by a user. In many instances, an input device, such as a stylus, is also provided to interact with the touch-sensitive display. A user can manipulate the stylus to interact with icons, letters, or other features on the touch-sensitive display to cause the unit to perform various functions. In many systems, a stylus provides a much more simple and accurate method of manipulating the small icons or other items on the touch-sensitive display than a user's finger. In some instances, the touch-sensitive displays are specifically designed for use with the stylus, such that a user would be virtually incapable of manipulating the screen if the stylus were not available. This poses significant issues in the event that a stylus is misplaced or lost. Typically, the stylus is not physically connected to the unit when removed from its predetermined storage region. As a result, it is not difficult for a user to inadvertently misplace or lose the stylus. In the event that the stylus is lost, the user's options are quite limited.

One conventional solution to the problem of a lost or missing stylus has been to include multiple styluses in the original packaging with the portable electronic device. Although providing the user with multiple styluses gives the user some flexibility in the event that a stylus is lost, this inherently increases the costs associated with the original product. Furthermore, it has been observed that many users do not carry multiple styluses with them, even if they were provided them in the original packaging. Therefore, the provision of multiple styluses does not aid the user in many circumstances. Another approach has been to market replacement styluses as an accessory to the portable electronic device. However, this also has its shortcomings, requiring a user to purchase a separate stylus on short notice in order to use his or her own device. This is particularly problematic for the business traveler who may not have access to any system for quickly purchasing a replacement stylus.

U.S. Pat. No. 6,518,957, issued to Lehtinen, et al., discloses a system where, in the event that the stylus is removed from its particular storage region inside the device for a predetermined length of time, an indication in the form of an alarm is emitted, notifying the user that the stylus has not been placed into its storage position. Although useful, this system may be subject to the issue of “false alarms,” where the stylus is left out of the storage region intentionally while the user has not completed using the device.

It would therefore be desirable to provide an improved mechanism for alerting the user as to when the stylus is missing while, at the same time, minimizing the number of false alarms that are transmitted.

### SUMMARY OF THE INVENTION

In accordance with the principles of the present invention, there is provided a portable electronic device comprising a housing having an open position and a closed position, a touch-sensitive input area, a data input device for interacting with the touch-sensitive input area and a data input device storage region for the data input device. The device also includes a system for alerting a user when the housing is in the closed position and the data input device is not positioned within the data input device storage region.

In one embodiment of the invention, a switch or sensor is operatively connected to the data input device storage region. In the event that the data input device is not located in the data input device storage region and the foldable housing is in the “closed” position, indicating that the touch-sensitive display is not in use, the circuitry provides an indication, in the form of a visual, audio or haptic alarm, to the user. This indication alerts the user that the data input device has not been correctly placed in the data input device storage region.

The system and method of the present invention greatly reduces the possibility of a false alarm by requiring that two separate and independent conditions be met before an indication is provided to a user. At the same time, the system and method of the present invention significantly reduces the possibility that a user will misplace the stylus or other data input device.

The present invention is applicable to any type of portable electronic device having a touch-sensitive display. Preferably, the present invention is used with portable communications devices such as “folding” mobile telephones, other types of phones, personal digital assistants, hand-held computers, portable radio communications devices, and combinations thereof.

### BRIEF DESCRIPTION OF THE DRAWINGS

FIG. 1 shows a front view of the outer casing of a foldable, portable electronic device constructed in accordance with the principles of the present invention;

FIG. 2 is a view showing the inside of the foldable portable electronic device of FIG. 1 when in the open position;

FIG. 3 is a structural diagram showing the functional elements of the foldable portable electronic device of FIG. 1, constructed in accordance with the principles of the present invention; and

FIG. 4 is a functional diagram showing the steps involved in determining whether an indication should be provided to the user regarding the location of the data input device.

### DETAILED DESCRIPTION OF THE INVENTION

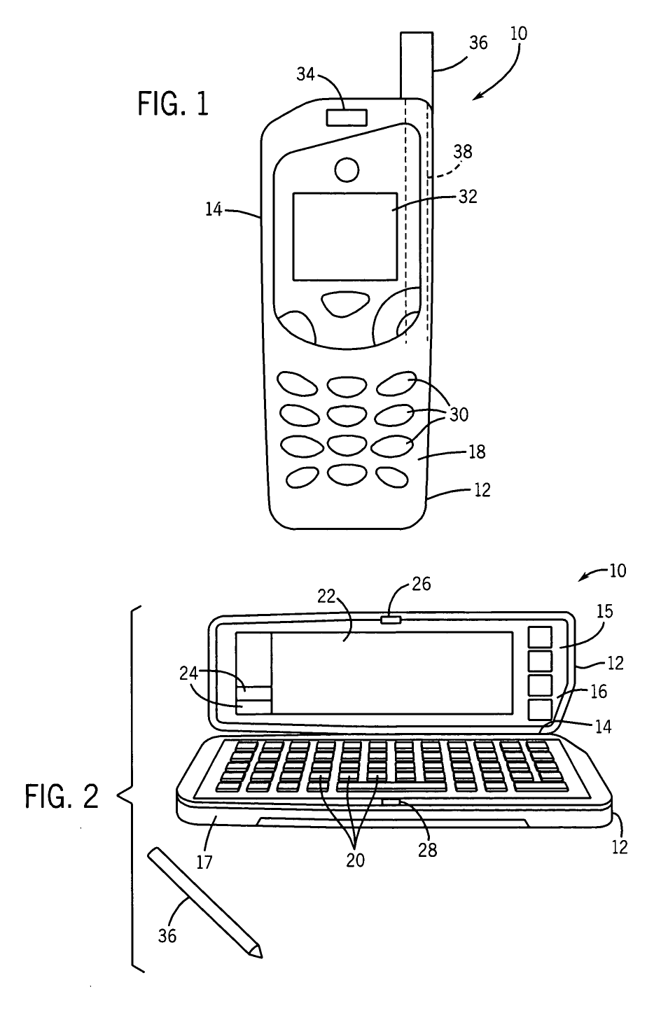

FIGS. 1 and 2 show the structure of a foldable, portable electronic device 10 constructed in accordance with the principles of the present invention. The foldable, portable electronic device 10, in a preferred embodiment of the invention, is a combination of a cellular telephone, hand-held computer, and a personal digital assistant. One such portable electronic device is a device marketed and sold by Nokia under the COMMUNICATOR brand name, and includes features such as including data and Internet connectivity, word processors, spreadsheets, presentation editors, viewers and a variety of office tools, as well as including various security features and also including items such as a VGA camera, video recorder and other items. However, the principles of the present invention can be applied to a wide variety of portable electronic devices, including, but not limited to, a personal digital assistant without an attached telephone, a stand-alone mobile phone, a personal computer, a personal notebook, other devices, and combinations thereof.

The foldable, portable electronic device 10 includes a housing 12 that is foldable along a hinge element 14. The housing 12 includes a housing inner portion 16 and a housing outer portion 18, as well as a housing upper portion 15 and a housing lower portion 17. As shown in FIG. 2, the housing inner portion 16 may include items such as keyboard keys 20, as well as a touch-sensitive display 22. The touch-sensitive display 22 can display various icons 24, as well as text, numbers, images, and other items. The housing inner portion 16 also preferably includes male and female latching members 26 and 28 that are used to keep the portable electronic device 10 in a closed position, when items found in the housing inner portion 16 are not in use. However, a wide variety of mechanisms besides male and female latching members 26 and 28 may also be used. For example, it is also possible to include a magnetic system for keeping the housing upper portion 15 and the housing lower portion 17 engaged with each other. It is also possible for a locking mechanism to be attached to the hinge element 14.

As shown in FIG. 1, the housing outer portion 18, in a preferred embodiment of the invention, comprises a telephone system which includes a plurality of telephone keys 30 and a display screen 32. The display screen 32 can either be strictly for display purposes or can also be touch-sensitive. The outer housing portion 18 also includes a speaker 34 to emit various sounds, as well as the voice of a person during a telephone conversation. A data input device 36, preferably in the form of a stylus, fits within a data input device storage region 38. The data input device storage region 38, in one preferred embodiment of the invention, comprises a slot inside a portion of the housing 12. It is also possible, however, that the data input device storage region 38 could take the form of a securing mechanism on the outside of the housing 12 against which the data input device 36 could be secured using one of a variety of methods known in the art.

As shown in FIG. 2, the data input device 36 is used to manipulate items on the touch-sensitive display 22. In particular, the data input device 36 can be used to actuate icons 24 on the touch-sensitive display 22 in order to initiate various commands, open computer programs, and perform other functions. It is also possible for the data input device 36 to interact with the touch-sensitive display 22 to perform functions such as dragging items across the touch-sensitive display 22, edit text, enlarge or resize objects, and perform many functions that are similar to those that a user can perform using a mouse with a personal computer.

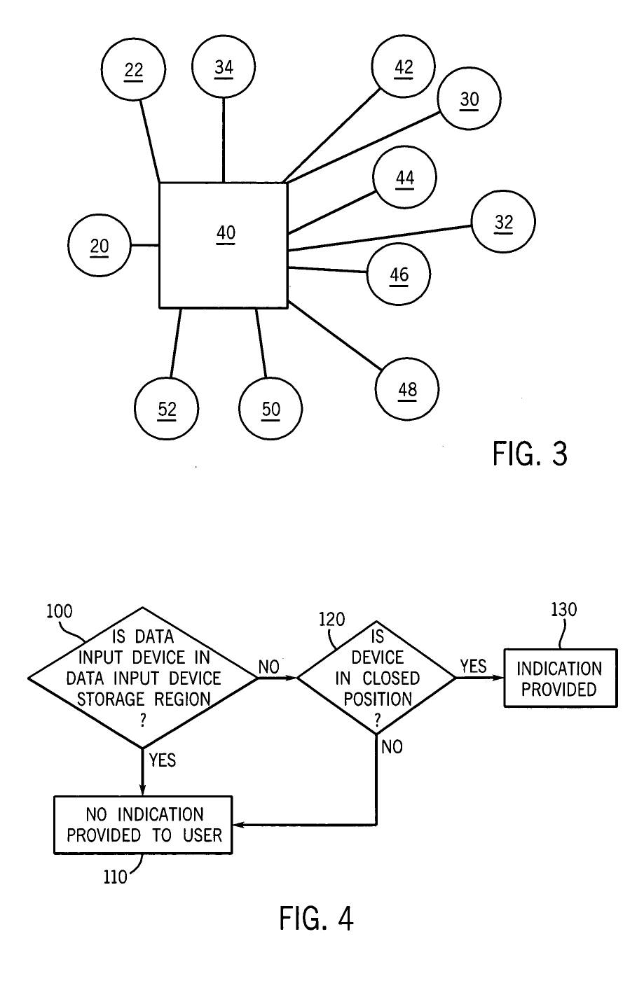

FIG. 3 is a functional diagram showing the key functional elements of the portable electronic device 10 of FIGS. 1 and 2. As shown in FIG. 3, a processor 40 processes the information that is received from a variety of sources, including, but not limited to, the touch-sensitive display 22, the telephone keys 30, the data input device 36, the keyboard keys 20, and other items such as a data communication link 46 and a telephone link 48. Various combinations of these items and others may also be operatively connected to the processor 40. In this particular embodiment of the invention, a data input device sensor 42 and a latching member sensor 44 are also operatively connected to the processor 40. The data input device sensor 42 is preferably positioned in the vicinity of the data input device storage region 38, while the latching member sensor 44 is preferably located in the vicinity of either the male latching member 26 or the female latching member 28.

Both the data input device sensor 42 and the latching member sensor 44 may be of any suitable form, such as mechanical, optical or electromechanical systems. When the data input device 36 is removed from the data input device storage region 38, this is detected by the data input device sensor 42, and a signal is sent to the processor 40. Similarly, when the data input device 36 is placed in its stored position, the data input device sensor 42 detects this and sends a corresponding signal to the processor 40. The signal from the data input device sensor 42 may also be used by the processor 40 to control various functions in the portable electronic device 10. Examples of such applications are the enabling of an icon on the touch-sensitive display 22, indicating that the data input device 36 has been removed.

Similarly, the latching member sensor 44 also sends one or more signals to the processor 40 when the male latching member 26 is either engaged or disengaged from the female latching member 28. Like the data input device sensor 42, the latching member sensor 44 can be formed in any suitable form, such as mechanical, optical or electromechanical means.

For both the data input device sensor 42 and the latching member sensor 44, instead of sending two different types of signals to indicate engagement or disengagement, it is possible that a signal could be sent to the processor 40 in only one state, while in the other state (such as when the male latching member 26 is disengaged from the female latching member 28) no signal of any type is sent to the processor 40. The processor 40 can then be programmed to recognize the lack of a signal being sent from the latching member sensor 44 accordingly. It is also possible to combine the data input device sensor 42 with a latching member sensor 44 such that a single sensor could perform both functions of recognizing when the data input device 36 is within the data input device storage region 38, and when the male latching member 26 is engaged with the female latching member 28.

Additionally, it is possible for the determination of whether the male and female latching members 26 and 28 are engaged with each other to occur simultaneously with or before the determination of whether the data input device 36 is in the data input device storage region 38. It is also possible that the determination regarding the status of the data input device sensor 42 and the latching member sensor 44 could occur either on a continuous basis or at regularly scheduled intervals. Furthermore, it is also possible for the processor 40 to include a built-in delay, such that an alarm is not sounded immediately after the portable electronic device 10 is closed, but instead, after a couple of seconds so that a user has the opportunity to re-insert the data input device 36 into the data input device storage region 38 before an indication is given.

FIG. 4 shows a functional flow diagram describing the circumstances under which an indication is sounded by the portable electronic device 10. These steps can be accomplished through the use of a computer software program stored in the memory of the portable electronic device 10. These steps could be performed by the processor 40 on a continuing basis or during regularly programmed time intervals, such as every five to ten seconds. Additionally, these steps could also be performed by the processor 40 based on interrupts generated by the data input device sensor 42 and/or the latching member sensor 44. At step 100, the processor 40 determines whether the data input device sensor 42 detects the presence of the data input device 36 within the data input device storage region 38. If the data input device 36 is present, then at step 110 no action is taken by the processor 40.

If the data input device 36 is not detected by the processor 40, the processor 40, then determines at step 120 whether the latching member sensor 44 detects the male latching member 26 as being engaged with the female latching member 28, indicating that the portable electronic device 10 is in the “closed” position. If the processor 40 detects that the male latching member 26 and the female latching member 28 are not engaged, this would be indicative that the portable electronic device 10 is in the open position, and that the user is likely using the data input device 36 to interact with the touch-sensitive display 22. In this instance at step 110, no action is taken by the processor 40. These steps could be undertaken in a variety of different orders, and all of these actions can be monitored, processed and executed through the use of computer code in a computer software program.

If the latching member sensor 44 detects that the male latching member 26 and the female latching member 28 are indeed engaged with each other, then this indicates that the touch-sensitive display 22 is not accessible by the user due to the fact that the portable electronic device 10 is in the “closed” position. Therefore, there is no need for the data input device 36 to be anywhere other than in the data input device storage region 38. At this stage, at Step 130, the processor 40 would generate an indication that is transmitted to the user that the data input device 36 is not correctly placed in the data input device storage region 38.

The indication generated by the processor 40 can take a variety of forms. In a preferred embodiment of the invention, the indication is an audible indication in the form of an alarm that is emitted through the speaker 34 at the direction of the processor 40. This audible alarm could be in the form of a series of beeps, or could be a customized sound at the discretion of the user. Alternatively, the indication generated by the processor 40 could be in the form of a vibration that a user would sense when holding or carrying the portable electronic device 10. Such a vibration could be generated by a vibrator 50, which is also operatively connected to the processor 40. In yet another embodiment of the invention, the indication could be visual in form, being generated by a light 52, also operatively connected to the processor 40.

As discussed previously, as well as the user interface being provided by means of a touch-sensitive or screen, the device may also include other user interface means, for example a mechanical keypad or voice input. The device may also be arranged to disable these means of user interface when a voice call is in progress.

The present invention is applicable to any communications device having a touch-sensitive display. Examples of such devices are radio telephone handsets, personal organizers, communicators, laptops, mobile telephones, etc. The invention is particularly applicable to mobile, wireless communication devices that are likely to be used by business travelers way from their home or office, but the present invention may also be applied to wired communication devices.

While preferred embodiments have been shown and described herein, it should be understood that changes and modifications can be made to the invention without departing from the invention in its broader aspects. For example, a wide variety of switches, sensors, and actuators can be used to detect whether the data input device 36 is correctly stored and whether the portable electronic device 10 is in the “closed” position. Additionally, the present invention could be used, not only in cases where the touch-sensitive display 22 is inaccessible to the user, but also in cases where, although the touch-sensitive display 22 is visible to the user, the touch-sensitive display 22 is still not usable by the user, such as in cases where the touch-sensitive display is disabled for some reason. Various features of the invention are defined in the following Claims.

1. A portable electronic device, comprising:
a housing having an open position and a closed position;
a touch-sensitive input area;
a data input device for interacting with the touch-sensitive input area;
a data input device storage region for the data input device; and
means for alerting a user when the housing is in the closed position and the data input device is not positioned within the data input device storage region.

2. The portable electronic device of claim 1, wherein the altering means comprises an audible alert transmitted through a speaker on the portable electronic device.

3. The portable electronic device of claim 1, wherein the altering means comprises a visual alert transmitted through the portable electronic device.

4. The portable electronic device of claim 1, wherein the altering means comprises a vibration transmitted through the portable electronic device.

5. The portable electronic device of claim 1, further comprising a securing mechanism for maintaining the housing in the second position.

6. The portable electronic device of claim 5, wherein the securing mechanism comprises:
a male latching member coupled to the housing; and
a female latching member coupled to the housing and in selective engagement with the male latching member.

7. The portable electronic device of claim 5, wherein the alerting means comprises:
a first sensor operatively connected to the data input device storage region; and
a second sensor operatively connected to at least a portion of the securing mechanism.

8. The portable electronic device of claim 1, wherein the data input device comprises a stylus.

9. The portable electronic device of claim 1, further comprising a data communication link for communicating with a remote system.

10. The portable electronic device of claim 1, further comprising a keyboard for inputting information.

11. The portable electronic device of claim 1, further comprising a telephone system for enabling voice communication.

12. An alert system for a portable electronic device having a touch-sensitive input area, comprising:
a touch-sensitive input area;
a data input device for interacting with the touch-sensitive input area;
a data input device storage region for the data input device; and
an alert for informing a user when the touch-sensitive input area is inaccessible to a user and the data input device is not positioned within the data input device storage region.

13. The alert system of claim 12, wherein the alert comprises an audible alert transmitted through a speaker on the portable electronic device.

14. The alert system of claim 12, wherein the alert comprises a visual alert transmitted through the portable electronic device.

15. The alert system of claim 12, wherein the alert comprises a vibration transmitted through the portable electronic device.

16. The alert system of claim 12, further comprising a securing mechanism for maintaining the portable electronic device in a position such that the touch-sensitive input area is not accessible by the user.

17. The alert system of claim 16, wherein the securing mechanism comprises:
a male latching member; and
a female latching member in selective engagement with the male latching member.

18. The alert system of claim 16, wherein the at least one actuator comprises:
a first sensor operatively connected to the data input device storage region; and
a second sensor operatively connected to at least a portion of the securing mechanism.

19. The alert system of claim 12, wherein the data input device comprises a stylus.

20. A method of providing an alert to a user of a portable electronic device, comprising the steps of:
providing a portable electronic device comprising a touch-sensitive input area, a data input device for interacting with the touch-sensitive input area, and a data input device storage region;
determining whether the touch-sensitive input area is accessible to a user;
determining whether the data input device is positioned within the data input device storage region; and
alerting a user when the touch-sensitive input area is not accessible to the user and the data input device is not positioned within the data input device storage region.

21. The method of claim 20, wherein the alerting step comprises transmitting an audible alert through a speaker on the portable electronic device.

22. The method of claim 20, wherein the alerting step comprises transmitting a visual alert through the portable electronic device.

23. The method of claim 20, wherein the alerting step comprises transmitting a vibration through the portable electronic device.

24. The method of claim 20, further comprising the step of providing a securing mechanism for maintaining the touch-sensitive input area is a position such that it is not accessible to the user.

25. The method of claim 24, wherein the securing mechanism comprises:
a male latching member; and
a female latching member in selective engagement with the male latching member.

26. The method of claim 20, wherein the data input device comprises a stylus.

27. A computer software program for alerting a user of a portable electronic device about information concerning the status of the portable electronic device, the portable electronic device including a touch-sensitive input area, a data input device for interacting with the touch-sensitive input area, and a data input device storage region, comprising:
computer code for determining whether the touch-sensitive input area is in a position such that it is accessible to a user;
computer code for determining whether the data input device is positioned within the data input device storage region; and
computer code for alerting a user when the touch-sensitive input area is not accessible to the user and the data input device is not positioned within the data input device storage region.
